(19) United States
(12) Patent Application Publication
(10) Pub. No.: US 2007/0071088 A1
(43) Pub. Date: Mar. 29, 2007

(54) Method and apparatus for entropy encoding and entropy decoding fine-granularity scalability layer video data

(75) Inventors: Bae-keun Lee, Bucheon-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/525,912

(22) Filed: Sep. 25, 2006

Related U.S. Application Data
(60) Provisional application No. 60/720,036, filed on Sep. 26, 2005.
(60) Provisional application No. 60/726,217, filed on Oct. 14, 2005.

(30) Foreign Application Priority Data
Jan. 12, 2006 (KR) 10-2006-0003605

(51) Int. Cl. H04B 1/66; H04N 11/04

(52) U.S. Cl. 375/240.1; 375/240.18; 375/240.24

(57) ABSTRACT

Methods and apparatuses for entropy encoding and decoding Fine-granularity Scalability (FGS) layer video data are provided. The encoding method includes extracting residual data between a first block and a second block in a layer lower than the FGS layer corresponding to the first block; obtaining transform coefficients; dividing the transform coefficients in the first block into at least two subblocks; calculating the length of a prefix of first coefficients in the subblocks; and combining the prefix with a suffix used to distinguish the first coefficients; and VLC encoding the first coefficients. The encoding apparatus includes a subblock divider, a prefix generator, and a significant coefficient encoding unit. The decoding method includes calculating a range of a transform coefficient using a length of a prefix of the transform coefficient; extracting a value of the transform coefficient; VLC decoding the value; and combining first and second subblocks having the decoded coefficients.

### CROSS-REFERENCE TO RELATED APPLICATION

This application claims priority from Korean Patent Application No. 10-2006-0003605 filed on Jan. 12, 2006 in the Korean Intellectual Property Office, and claims the benefit of priority from U.S. Provisional Patent Applications Nos. 60/720,036 and 60/726,217 filed on Sep. 26, 2005 and Oct. 14, 2005, respectively, in the United States Patent and Trademark Office, the disclosures of which are incorporated herein by reference in their entirety.

### BACKGROUND OF THE INVENTION

1. Field of the Invention

Methods and apparatuses consistent with the present invention relate to encoding and decoding of a video signal and, more particularly, to entropy encoding and decoding of a video signal in a Fine-Granularity Scalability (FGS) layer block.

2. Description of the Related Art

Development of communication technologies such as the Internet has led to an increase in video communication in addition to text and voice communication. However, consumers have not been satisfied with existing text-based communication schemes. To satisfy various consumer needs, services for multimedia data containing text, images, music and the like have been increasingly provided. Multimedia data is usually voluminous and requires a large capacity storage medium. Also, a wide bandwidth is required for transmitting the multimedia data. Accordingly, it is required to use a compressed coding scheme when transmitting multimedia data.

A basic principle of data compression is to eliminate redundancy in the data. Data can be compressed by removing spatial redundancy referring to the duplication of identical colors or objects in an image, temporal redundancy referring to little or no variation between adjacent frames in a moving picture or successive repetition of the same sounds in audio, or perceptual-visual redundancy referring to the limitations of human vision and the inability to hear high frequencies. In general video coding, temporal redundancy is removed by temporal filtering based on motion compensation, and spatial redundancy is removed by spatial transformation.

Redundancy-removed data is again subjected to quantization for lossy coding using a predetermined quantization step. The quantized data is finally subjected to entropy coding for lossless coding.

Standardization work for implementation of multilayer-based coding techniques using the H.264 standard is actively being pursued at present by a Joint Video Team (JVT) of the International Organization for Standardization/International Electrotechnical Commission (ISO/IEC) and International Telecommunication Union (ITU).

Entropy coding techniques currently being used in the H.264 standard include Context-Adaptive Variable Length Coding (CAVLC), Context-Adaptive Binary Arithmetic Coding (CABAC), and exponential Golomb (Exp_Golomb).

Table 1 shows entropy coding techniques used for each to-be-coded parameter under the H.264 standard.

TABLE 1

| | entropy_coding_mode = | entropy_coding_mode = |
|---|---|---|
| Coded parameter | 0 | 1 |
| Macroblock_type | Exp_Golomb | CABAC |
| Macroblock_pattern | | |
| Quantization | | |
| parameter | | |
| Reference | | |
| frame index | | |
| Motion vector | | |
| Residual data | CAVLC | |

According to Table 1, if an entropy_coding_mode flag is 0, Exp_Golomb is used in coding the macroblock type indicating whether a corresponding macroblock is in an inter prediction mode or intra prediction mode, the macroblock pattern specifying the types of a subblock that form a macroblock, the quantization parameter which is an index to determine a quantization step, the reference flame index specifying the frame number which is referred to in an inter prediction mode, and the motion vector, while CAVAC is used in encoding the residual data defining a difference between an original image and a predicted image.

On the other hand if the entropy_coding_mode flag is 1, all the parameters are coded by CABAC.

Since CABAC exhibits high performance with respect to a parameter having high complexity, Variable Length Coding (VLC) based entropy coding, e.g., CAVLC, is set as a basic profile.

FIG. 1 illustrates a FGS coding pass. As proposed in the Joint Scalable Video Model (JSVM) 3.0, the encoding of a FGS layer is performed in two types of encoding passes: a significant pass and a refinement pass. The significant pass is used to determine a FGS layer block from a zero-valued base layer block. The refinement pass coding is used to determine the FGS layer block from a non-zero valued base layer block. Transform indices are output in each scanning cycle. From the viewpoint of VLC, since a FGS layer is commonly encoded in a significant pass, encoding in a significant pass can improve encoding efficiency.

Thus, there is a need for a method and apparatus for encoding a FGS layer using VLC to achieve high encoding efficiency.

### SUMMARY OF THE INVENTION

Exemplary embodiments of the present invention provide CAVLC for a significant pass in encoding an 8×8 block in a FGS layer.

Exemplary embodiments of the present invention also provide a method for applying a 4×4 block encoding process to an 8×8 block encoding process.

These and other aspects of the present invention will be described in or be apparent from the following description of certain exemplary embodiments.

According to an aspect of the present invention, there is provided a method for entropy encoding a first block of a Fine-Granularity Scalability (FGS) layer in a multi-layer video signal using lossless Variable-Length Coding (VLC), the method comprising extracting residual data between the first block and a second block in a layer lower than the FGS layer corresponding to the first block; obtaining transform coefficients; dividing the transform coefficients in the first block into at least two subblocks; calculating the length of a prefix of first coefficients in the at least two subblocks; and combining the prefix with a suffix used to distinguish the first coefficients; and VLC encoding the first coefficients.

According to another aspect of the present invention, there is provided a method for entropy decoding a first block of a Fine-Granularity Scalability (FGS) layer in a multi-layer video signal using lossless Variable-Length Coding (VLC), the method comprising calculating a range of a transform coefficient using a length of a prefix of the transform coefficient extracted from a VLC coded bitstream; extracting a value of the transform coefficient from the range using a suffix of the coded transform coefficient; VLC decoding the value of transform coefficient; and combining first and second subblocks having the decoded coefficients to generate the first block.

According to still another aspect of the present invention, there is provided an entropy encoder for losslessly Variable-Length Coding (VLC) encoding a transform coefficient in a first block of a Fine-Granularity Scalability (FGS) layer in a multi-layer video signal, the encoder comprising a subblock divider which divides transform coefficients in the first block into at least two subblocks, the transform coefficients being derived from residual data between the first block and a second block in a layer lower than the FGS layer corresponding to the first block; a prefix generator which calculates a length of a prefix of first coefficients in the at least two subblocks; and a significant coefficient encoding unit which combines the prefix with a suffix used to distinguish the first coefficients and which VLC encodes the first coefficients.

According to yet another aspect of the present invention, there is provided an entropy decoder for losslessly decoding transform coefficients in a first block in a Fine-Granularity Scalability (FGS) layer of a multi-layer video signal, the entropy decoder comprising a transform coefficient calculator which calculates a range of a transform coefficient using a length of a prefix of the transform coefficient extracted from a Variable-Length Coding (VLC) coded bitstream of the transform coefficient; a decoding unit which extracts a value of the transform coefficient from the range using a suffix of the coded transform coefficient and which VLC decodes the value of the transform coefficient; and a block generator which combines first and second subblocks having the VLC decoded transform coefficient value to produce the first block.

### BRIEF DESCRIPTION OF THE DRAWINGS

The above and other aspects of the present invention will become more apparent by describing in detail certain exemplary embodiments thereof with reference to the attached drawings in which:

FIG. 1 illustrates a Fine-granularity Scalability (FGS) coding pass;

FIG. 2 illustrates a process of encoding a FGS layer using VLC in transformation of a 4×4 block;

FIG. 3 illustrates a process of encoding an 8×8 block in a FGS layer using VLC according to an exemplary embodiment of the present invention;

FIG. 4 illustrates a scan order for determining a subblock according to an exemplary embodiment of the present invention;

FIG. 5 illustrates a process of encoding a subblock in a 8×8 FGS block using CAVLC according to an exemplary embodiment of the present invention;

FIG. 6 illustrates a process of generating a subblock to apply CAVLC to an 8×8 block according to an exemplary embodiment of the present invention;

FIG. 7 illustrates a CAVLC process according to an exemplary embodiment of the present invention;

FIG. 8 illustrates a CAVLC decoding process according to an exemplary embodiment of the present invention;

FIG. 9 illustrates a, configuration of an entropy encoding unit in an encoder according to an exemplary embodiment of the present invention; and

FIG. 10 illustrates a configuration of an entropy decoding unit in a decoder according to an exemplary embodiment of the present invention.

### DETAILED DESCRIPTION OF EXEMPLARY EMBODIMENTS OF THE PRESENT INVENTION

Exemplary embodiments of the present invention will now be described more fully with reference to the accompanying drawings, in which exemplary embodiments of the invention are shown.

Advantages and aspects of the present invention and methods of accomplishing the same may be understood more readily by reference to the following detailed description of exemplary embodiments and the accompanying drawings. The present inventive concept may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Exemplary embodiments of the present invention will now be described with reference to each block of the flowchart illustrations of a method and apparatus for entropy encoding and decoding of video data in a FGS layer using CAVLC. It will be understood that each block of the flowchart illustrations, and combinations of block in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or block.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or block.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or block.

Each block of the flowchart illustrations may represent a module, segment, or portion of code, which comprises one or more executable instructions for implementing the specified logical function(s). It should also be noted that in some alternative implementations, the functions noted in the block may occur out of order. For example, two blocks shown in succession may in fact be executed substantially concurrently or the block may sometimes be executed in the reverse order, depending upon the functionality involved.

CAVLC uses information about contiguous blocks that have been recently encoded. In CAVLC, VLC is performed using one of a plurality of coding reference tables that is chosen according to information about a neighboring block of a block that is currently being coded. CAVLC is used to encode residual, i.e., zig-zag scanned transform coefficient blocks, during video coding. CAVLC is configured to exploit several characteristics of quantized blocks.

After prediction, transformation and quantization, blocks mostly have zero coefficients. CAVLC uses run-level coding to represent a sequence of zeros in a compressed format. After a zig-zag scan, the highest non-zero coefficients usually have a sequence of ±1 values. CAVLC compresses the number of high-frequency ±1 coefficients. Numbers of non-zero coefficients in neighboring blocks are correlated. The number of coefficients is encoded using a look-up table (LUT); the choice of an LUT depends on the numbers of non-zero coefficients in the neighboring block. The level (magnitude) of non-zero coefficients tends to be high at a beginning stage of a rearranged array and gradually decreases towards a higher frequency. In CAVLC, the VLC LUT for a level parameter is chosen adaptive to the recently-coded level.

CAVLC of a block of transform coefficients proceeds as follows.

First, the number of non-zero transform coefficients and the number of high frequency ±1 coefficients within a block are encoded and signs of the high frequency ±1 coefficients in each block are encoded. Next, the levels of the remaining non-zero coefficients are encoded. Then, the total number of zeros occurring before the last coefficient is encoded. Lastly, each run of zeros is encoded.

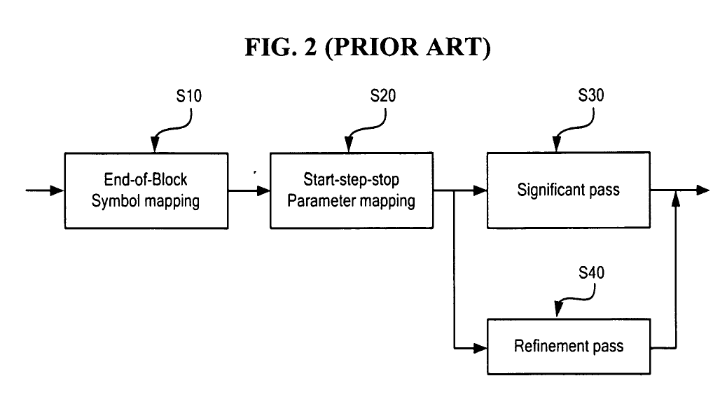

FIG. 2 illustrates an encoding process using VLC in a 4×4 transform. Referring to FIG. 2, at an initial stage of CAVLC, End-of-Block (EOB) symbol mapping (S10) and start-step-stop mapping (S20) are performed to generate two initialization vectors. A significant pass (S30) and a refinement pass (S40) are performed based on the two initialization vectors. In the significant pass, each run of significant coefficients is encoded. In the refinement pass, one VLC table is used. The VLC table efficiently exploits a characteristic of refinement bits, that is, refinement bits have a high statistical probability of being “0.”

During the EOB symbol mapping, a symbol representing an EOB for scan index is specified. In the start-step-stop parameter mapping, coding is specified by parameter m. When significant data is encoded, the value of m is determined by a scan index and a recent non-zero index in a base layer coefficient. The parameter m is also run-level coded.

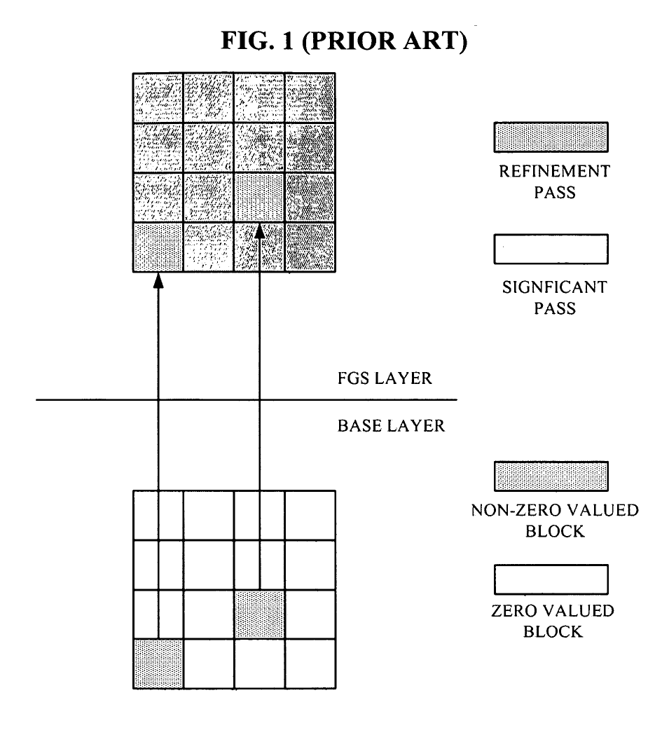

As shown in FIG. 1, the significant pass checks whether there are any significant coefficients in a block. If there are no significant coefficient, an EOB marker is output to define that there are no more new significant coefficients in the same block. Otherwise, coding of the block proceeds.

In the refinement pass, all block are encoded at a time as shown in FIG. 1. As refinement bits are accumulated by group, a code word is transmitted according to Table 2.

TABLE 2

| Symbol | Code word |
|---|---|
| 0000 | 00 |
| 0001 | 010 |
| 0010 | 011 |
| 0011 | 11000 |
| 0100 | 100 |
| 0101 | 11001 |
| 0110 | 11010 |
| 0111 | 111100 |
| 1000 | 101 |
| 1001 | 11011 |
| 1010 | 11100 |
| 1011 | 111101 |
| 1100 | 11101 |
| 1101 | 111110 |
| 1110 | 1111110 |
| 1111 | 1111111 |

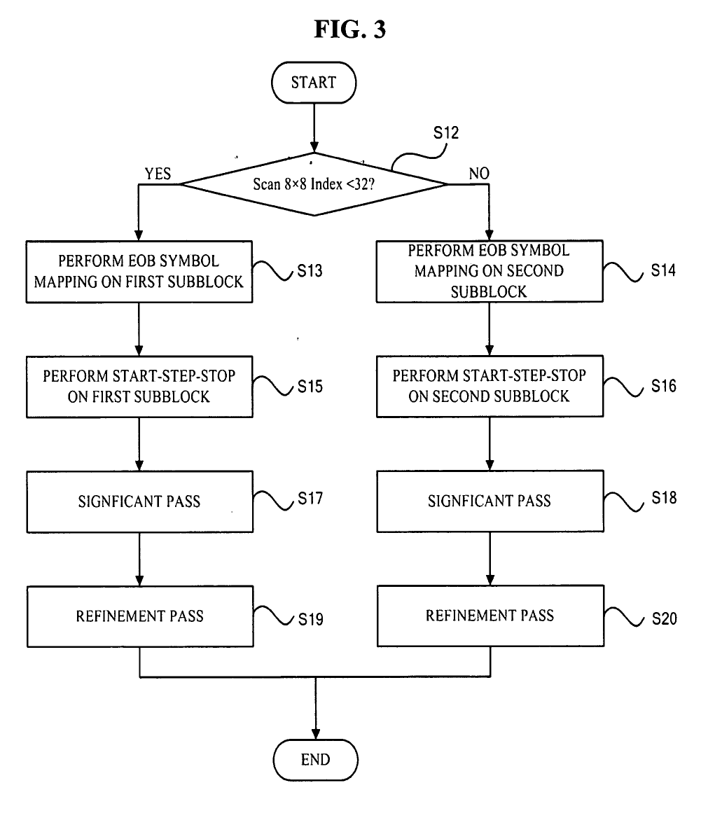

FIG. 3 illustrates a process of encoding an 8×8 block in a FGS layer using VLC according to an exemplary embodiment of the present invention.

In an 8×8 transform, single flag coding is not performed. That is, a 8×8 is divided into subblocks and CAVLC is performed on each subblock like in the 4×4 transform shown in FIG. 2. When the 8×8 block is partition into subblocks, the number of coefficients to be encoded decreases. That is, while a total number of the 8×8 block coefficients is 64, each subblock has 32 or 16 coefficients. Thus, when CAVLC is applied to each subblock, the number of coefficients to be encoded is reduced and the run length decreases, thus decreasing the possibility of increasing the size of a symbol.

Referring to FIG. 3, in order to partition a 8×8 block into two subblocks, in operation S12, a value of Scan8×8Index representing a scan order in the 8×8 block is checked. If the value of Scan8×8Index is less than 32, a first subblock is chosen. Conversely, when the value of Scan8×8Index is grater than or equal to 32, a second subblock is chosen. In operations S13 and S14, EOB symbol mapping is performed on the first or second subblocks, respectively. In operations S15 and S16, start-step- stop parameter mapping is performed on the first or second blocks, respectively. Coding for a significant pass is performed in operations S17 and S18, and coding for a refinement pass is performed in operations S19 and S20.

As a result of the above-mentioned process, transform coefficients in the two subblock are encoded using CAVLC. In order to divide the 8×8 block into four subblocks, the value of Scan8×8Index may have four subranges (Scan8×8Index<16, 16<Scan8×8Index<32, 32<Scan8×8Index<48, and 48<Scan8×8Index<64).

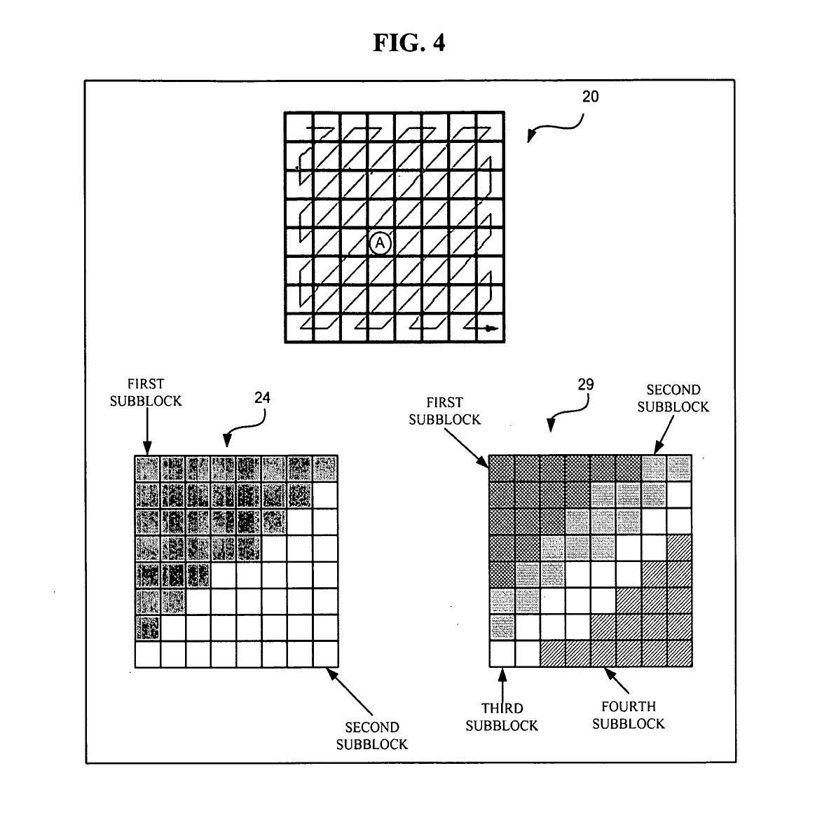

FIG. 4 illustrates a scan order for determining a subblock according to an exemplary embodiment of the present invention. Referring to FIG. 4, a scan order in a 8×8 FGS block 20 increases in a direction indicated by an arrow. Encircled reference symbol A denotes a point where the Scan8×8Index is 32. The block scanned before the point A is determined as being the first subblock while the block scanned after the point A is determined as the second subblock. In exemplary embodiments of the present invention, a block is divided into two or four subblocks according to a scan order, as indicated by reference numerals 24 and 29.

When the CAVLC transformation method used for the 4×4 block is applied to encoding of each subblock shown in FIG. 4, the length of a run is decreased, thus increasing the overall encoding efficiency, compared to encoding of an 8×8 block.

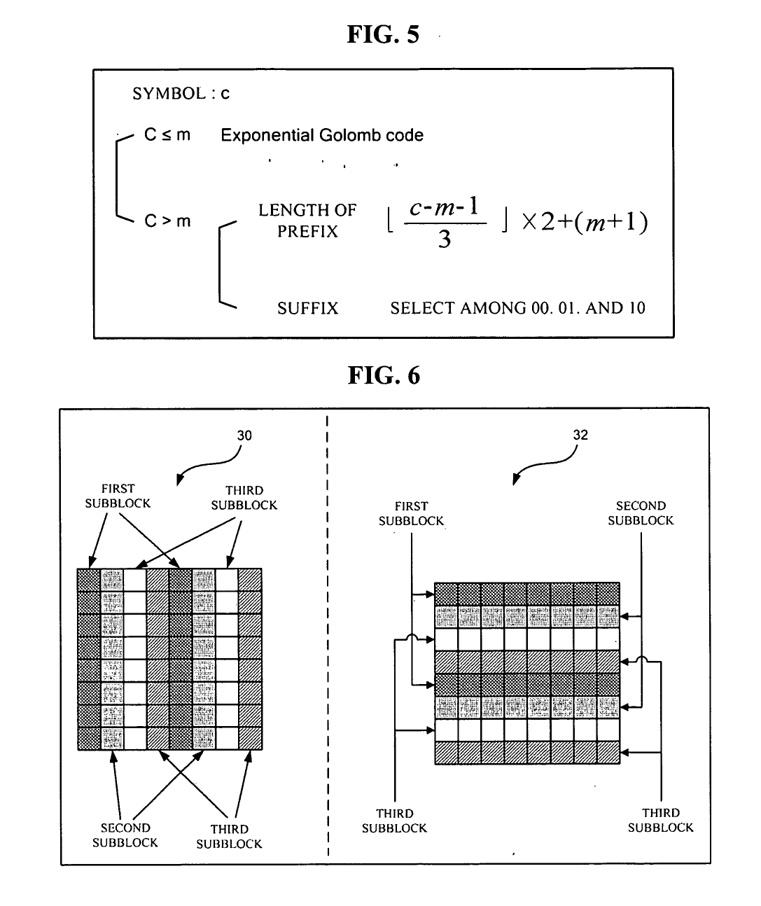

FIG. 5 illustrates a process of encoding a subblock in an 8×8 FGS block using CAVLC according to an exemplary embodiment of the present invention. Specifically, FIG. 5 illustrates a process of obtaining a prefix of consecutive 1's having a length of p and a suffix used to distinguish each symbol to encode a significant coefficient in a FGS block.

Referring to FIG. 5, when the value c of a symbol to be encoded is less than or equal to m, the symbol is encoded using an exponential Golomb code. Conversely, when the value c is greater than m, the length of the prefix is derived and a suffix is chosen for encoding. Table 3 shows the code word encoding the symbol in the case where m is 1 according to an exemplary embodiment of FIG. 5.

TABLE 3

| Symbol | Code word where m = 1 |
|---|---|
| 0 | 0 |
| 1 | 01 |
| 2 | 1100 |
| 3 | 1101 |
| 4 | 1110 |
| 5 | 111100 |
| 6 | 111101 |
| 7 | 111110 |

In Table 3, the prefix is represented by consecutive 1's and the length of the consecutive 1's is determined by the size of the symbol and m. The value of m is determined by a scan index and recent non-zero index of a base layer coefficient in a 16×16 table. The length of the prefix is defined by Expression (1):

$$[ \frac{c - m - 1}{3} ] \times 2 + ( m + 1 ) \qquad ( 1 )$$

After the significant pass shown in FIG. 5 is completed, encoding using VLC is performed for a refinement pass. Table 4 is referred to in performing the encoding using VLC.

TABLE 4

| Symbol | Code word |
|---|---|
| 0000 | 00 |
| 0001 | 010 |
| 0010 | 011 |
| 0011 | 11000 |
| 0100 | 100 |
| 0101 | 11001 |
| 0110 | 11010 |
| 0111 | 111100 |
| 1000 | 101 |
| 1001 | 11011 |
| 1010 | 11100 |
| 1011 | 111101 |
| 1100 | 11101 |
| 1101 | 111110 |
| 1110 | 1111110 |
| 1111 | 1111111 |

FIG. 6 illustrates a process of generating a subblock to apply CAVLC to a 8×8 block according to an exemplary embodiment of the present invention. While FIG. 4 illustrates the 8×8 block being partitioned into two or four subblock, FIG. 6 shows it is divided horizontally or vertically into subblocks. Reference designator 30 shows a case where the 8×8 block is divided vertically into four 8×2 subblocks. Since the 8×2 subblocks each have 16 transform coefficients, is the 8×2 subblocks are encoded using CAVLC like in the 4×4 block having 16 transform coefficients. Similarly, reference designator 32 shows a case where the 8×8 block is divided horizontally into four 2×8 subblocks. Since the 2×8 subblocks each have 16 transform coefficients, the 2×8 subblocks are encoded using CAVLC like a 4×4 block having 16 transform coefficients.

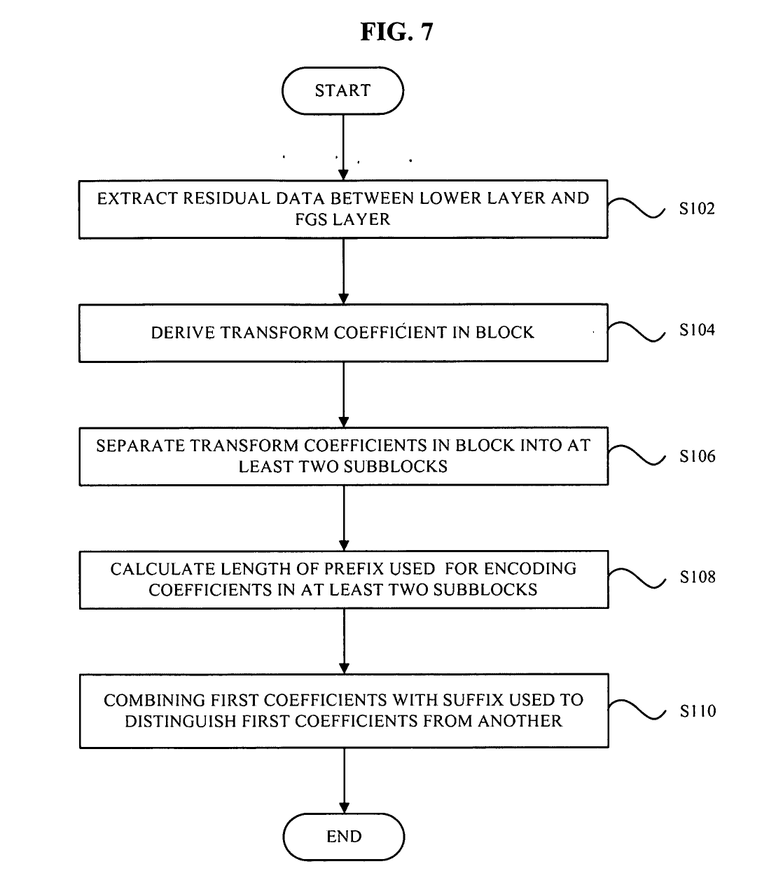

FIG. 7 illustrates a CAVLC process according to an exemplary embodiment of the present invention.

Referring to FIG. 7, in operation S102, residual data between a FGS layer and a lower layer is extracted. The lower layer may be a base layer or FGS layer. In operation S104, transform coefficients of the 8×8 block are derived from extracted residual data. Non-zero coefficients are significant coefficients and FIG.7 illustrates a process of encoding non-zero significant coefficients using VLC. The transform coefficients are obtained after quantizing residual data. In operation S106, transform coefficients are separated into at least two subblocks. For example, 64 transform coefficients in the 8×8 block are divided into two subblocks, each having 32 transform coefficients, or four subblocks, each having 16 transform coefficients. In operations S108 and S110, CAVLC is performed on each subblock.

In operation S108, the length of a prefix of coefficients of the respective subblocks is calculated. The length of the prefix may be calculated as illustrated in the Expression (1) and FIG. 5. The prefix is composed of consecutive 1's or 0's. As described above, m is used to obtain a length of the prefix.

In operation S110, a suffix is obtained to distinguish the transform coefficient from others and combined with the prefix obtained in operation S108 to encode the transform coefficient. That is, after encoding of one subblock is completed, encoding of another subblock using 4×4 CAVLC proceeds.

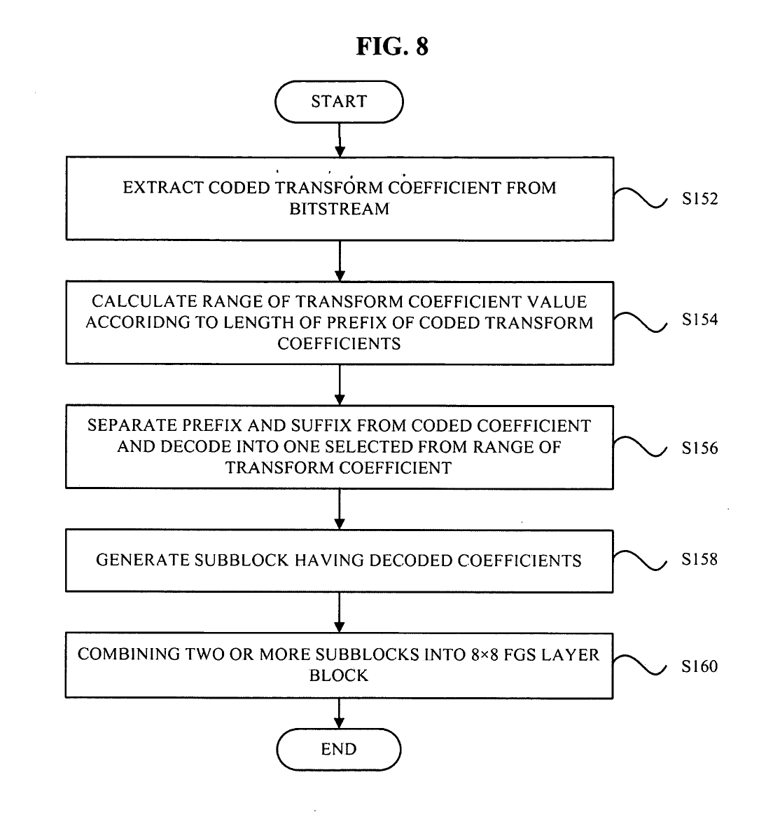

FIG. 8 illustrates a CAVLC decoding process according to an exemplary embodiment of the present invention. Referring to FIG. 8, in operation S152, a VLC-coded transform coefficient is extracted from an encoded bitstream. In operation S154, the length of the prefix of the encoded transform coefficient is calculated using prescribed bit patterns, such as consecutive 1's or 0's. Once the length of the prefix is determined and a value of m is extracted from a 16×16 table for the value of m, the value of a symbol c can be obtained using the Expression (1) shown above. In this case, the symbol c can have one of three values and may be calculated using the value of the suffix. For example, assume that a coded coefficient is 1100, as shown in Table 3. Here, the length of a prefix is 2 and m is 1. Accordingly, the symbol c may have one of three values 2, 3, and 4. The value of symbol c can be determined as being ‘2’ by the suffix ‘00’. Thus, in operation S156, the coded transform coefficient is decoded to one value selected from a range of a transform coefficient value.

In operation S158, a subblock having decoded transform coefficients is generated. By performing the operations S152 through S158, transform coefficients in all subblocks in an 8×8 FGS layer block are decoded. The subblocks are combined together to generate the 8×8 FGS layer block. The subblocks can be located within the 8×8 FGS layer block as shown in FIGS. 4 and 6.

In exemplary embodiments of the present invention, a “unit”, “part” or a “module” indicates a software component or a hardware component such as a field-programmable gate array (FPGA) or an application-specific integrated circuit (ASIC). The unit performs a particular function but is not restricted to software and hardware. The unit may be included in an addressable storage medium or may be configured to play one or more processors. Accordingly, units may include components such as software components, object-oriented software components, class components, and task components, processes, functions, attributes, procedures, subroutines, segments of program code, drivers, firmware, microcodes, circuits, data, databases, data structures, tables, arrays, or parameters. Components and features provided by units may be combined into a smaller number of components and a smaller number of units, or may be divided into a greater number of components and a greater number of units. In addition, components and modules may be implemented such that they use one or more central processing units (CPUs) in a device.

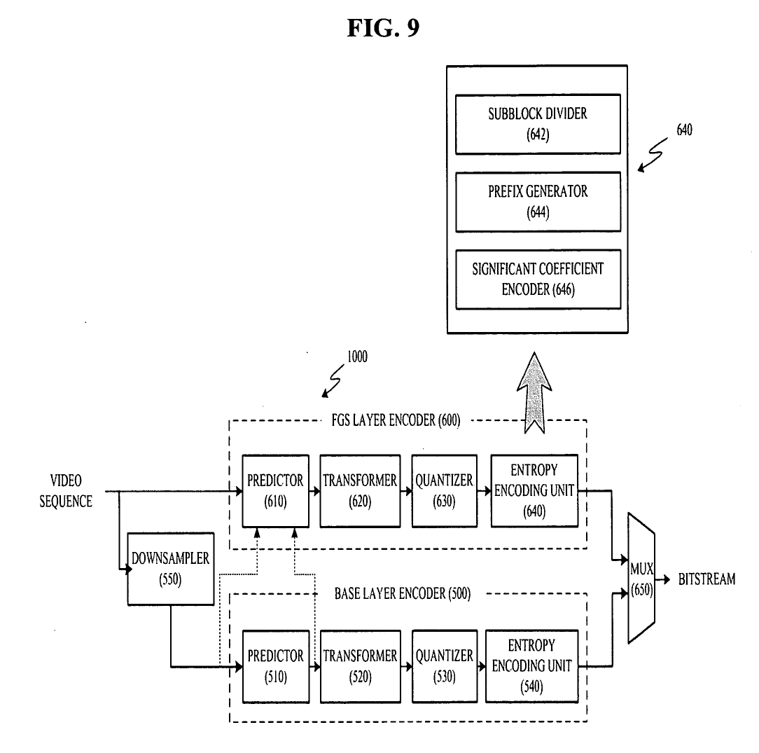

FIG. 9 illustrates the configuration of an entropy encoding unit in an encoder according to an exemplary embodiment of the present invention.

Referring to FIG. 9, an original video sequence is fed into a FGS layer encoder 600. When a base layer has a different resolution than a FGS layer, the original video sequence is subjected to downsampling by a downsampler 550 and the downsampled video sequence is input to a base layer encoder 500.

A predictor 610 subtracts an image predicted using a prediction technique, which may be predetermined, from a current macroblock to obtain a residual signal. Directional intra prediction, inter prediction, intra BL prediction, and residual prediction may be used for prediction.

A transformer 620 transforms the residual signal into a transform coefficient using spatial transform such as Discrete Cosine Transform (DCT), wavelet transform, or similar transform.

A quantizer 630 quantizes the transform coefficient according to a given quantization step (as the quantization step increases, the level of data loss or compression ratio increases) to generate a quantization coefficient.

The base layer encoder 500 includes a predictor 510, a transformer 520, and a quantizer 530 having the same functions as their counterparts in the FGS layer encoder 600. However, unlike the predictor 610, the predictor 510 cannot use Intra BL prediction or residual prediction.

An entropy encoding unit 640 losslessly encodes the quantization coefficient into a FGS layer bitstream. Similarly, an entropy encoding unit 540 losslessly encodes a quantization coefficient into a base layer bitstream. A Mux 650 combines the FGS layer bitstream with the base layer bitstream into a bitstream to be sent to a video decoder.

More specifically, the entropy encoding unit 640 includes a subblock divider 642, a prefix generator 644, and a significant coefficient encoder 646.

The subblock divider 642 divides transform coefficients in the 8×8 FGS block into at least two subblocks. As described above, in order to divide transform coefficients into the at least two subblocks, the transform coefficients may be divided into two or more groups according to a scan order in the 8×8 block and coefficients at the same locations of the two or more groups are combined to generate a subblock.

The prefix generator 644 calculates the length of a prefix to generate a prefix to encode a transform coefficient in a subblock using CAVLC. The length of the prefix can be calculated using the Expression (1) above. Once the length of the prefix is obtained, the prefix can be generated using a certain pattern, which may be predetermined, such as consecutive 1's or 0's. A 16×16 table for deriving the value m in the Expression (1) may be used to calculate the length of the prefix. The 16×16 table has a scan index in 4×4 subblock and a recent non-zero index in a base layer coefficient.

The significant coefficient encoder 646 combines the prefix with a suffix used to distinguish the transform coefficient from another to encode the transform coefficient.

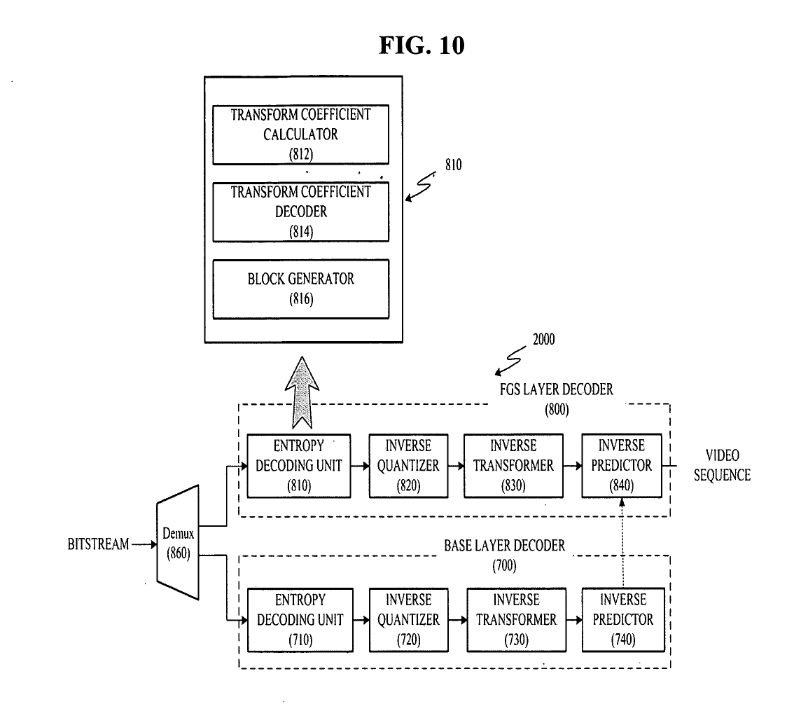

FIG. 10 illustrates the configuration of an entropy decoding unit in a decoder according to an exemplary embodiment of the present invention.

An input bitstream is divided into a FGS bitstream and a base layer bitstream by a Demux 860 and are then fed into a FGS layer encoder 800 and a base layer decoder 700, respectively.

An entropy decoding unit 810 performs inverse operation of the entropy encoding unit 640. That is, the entropy decoding unit 810 losslessly decodes the FGS layer bitstream to reconstruct a quantization coefficient. The entropy decoding unit 810 includes a transform coefficient calculator 812, a transform coefficient decoder 814, and a block generator 816. The transform coefficient calculator 812 extracts VLC-coded transform coefficients from the FGS layer bitstream and uses the length of a prefix of the transform coefficients to calculate a range of transform coefficients.

The transform coefficient decoder 814 uses a suffix of the encoded transform coefficient to extract the value of the transform coefficient from the range of transform coefficients and decodes the transform coefficient using CAVLC. The block generator 816 uses a subblock generated by combining decoded transform coefficients to generate 8×8 block.

An inverse quantizer 820 inversely quantizes the reconstructed quantization coefficient according to a quantization step used by the quantizer 630.

An inverse transformer 830 inversely transforms the inversely quantized coefficient using an inverse transform technique such as inverse DCT, inverse wavelet, or similar inverse transform.

An inverse predictor 840 obtains a predicted image by means of the same technique that is used by the predictor 610 and adds the predicted image to the inversely transformed result to reconstruct a video sequence.

The base layer decoder 700 includes an entropy decoding unit 710, an inverse quantizer 720, an inverse transformer 730, and an inverse predictor 740 having the same functions as their counterparts in the FGS layer decoder 800. However, unlike the predictor 610, the predictor 510 cannot use Intra BL prediction nor residual prediction.

Exemplary embodiments of the present invention allow CAVLC in a significant pass in encoding a 8×8 block in a FGS layer.

Exemplary embodiments of the present invention can also apply a 4×4 block encoding process of to a 8×8 block encoding process.

It will be apparent to those skilled in the art that various modifications and changes may be made thereto without departing from the scope and spirit of the invention. Therefore, it should be understood that the above exemplary embodiments are not restrictive but illustrative in all aspects. The scope of the present invention is defined by the appended claims rather than the detailed description of the invention. All modifications and changes derived from the scope and spirit of the claims and equivalents thereof should be construed to be included in the scope of the present invention.

What is claimed is:

1. A method for entropy encoding a first block of a Fine-Granularity Scalability (FGS) layer in a multi-layer video signal using lossless Variable-Length Coding (VLC), the method comprising:
extracting residual data between the first block and a second block in a layer lower than the FGS layer corresponding to the first block;
obtaining transform coefficients;
dividing the transform coefficients in the first block into at least two subblocks;
calculating the length of a prefix of first coefficients in the at least two subblocks; and
combining the prefix with a suffix used to distinguish the first coefficients; and
VLC encoding the first coefficients.

2. The method of claim 1, wherein the prefix comprises consecutive 1's or 0's and the length of the prefix is calculated by:
$$[ \frac{c - m - 1}{3} ] \times 2 + ( m + 1 )$$
where m is an integer that is greater than or equal to 0.

3. The method of claim 2, wherein m is extracted from a 16×16 table and the 16×16 table has a scan index in a 4×4 subblock and a recent non-zero index in lower layer coefficients.

4. The method of claim 1, wherein a total number of the at least two subblocks is 2 and each subblock has 32 coefficients.

5. The method of claim 1, wherein a total number of the at least two subblocks is 4 and each subblock has 16 coefficients.

6. The method of claim 1, wherein the dividing of the transform coefficients comprises dividing the transform coefficients being scanned into a plurality of groups according to a scan order of the first block.

7. The method of claim 1, wherein the dividing of the transform coefficients comprises dividing the first block into at least two groups and combining coefficients at same locations of the at least two groups to generate a subblock.

8. A method for entropy decoding a first block of a Fine-Granularity Scalability (FGS) layer in a multi-layer video signal using lossless Variable-Length Coding (VLC), the method comprising:
calculating a range of a transform coefficient using a length of a prefix of the transform coefficient extracted from a VLC coded bitstream;
extracting a value of the transform coefficient from the range using a suffix of the coded transform coefficient;
VLC decoding the value of transform coefficient; and
combining first and second subblocks having the decoded coefficients to generate the first block.

9. The method of claim 8, wherein the prefix comprises consecutive 1's or 0's and the length of the prefix is calculated by:
$$[ \frac{c - m - 1}{3} ] \times 2 + ( m + 1 )$$
where m is an integer that is greater than or equal to 0.

10. The method of claim 9, wherein m is extracted from a 16×16 table and the 16×16 table has a scan index in a 4×4 subblock and a recent non-zero index in lower layer coefficients.

11. The method of claim 8, wherein a total number of the at least two subblocks is 4 and each subblock has 32 coefficients.

12. The method of claim 8, wherein a total number of the at least two subblocks is 2 and each subblock has 16 coefficients.

13. The method of claim 8, wherein the first subblock and the second subblock are obtained by dividing the transform coefficients being scanned into a plurality of groups according to a scan order of the first block.

14. The method of claim 8, wherein the subblock is obtained by dividing the first block into at least two groups and combining coefficients at same locations of the plurality of groups.

15. An entropy encoder for losslessly Variable-Length Coding (VLC) encoding a transform coefficient in a first block of a Fine-Granularity Scalability (FGS) layer in a multi-layer video signal, the encoder comprising:
a subblock divider which divides transform coefficients in the first block into at least two subblocks, the transform coefficients being derived from residual data between the first block and a second block in a layer lower than the FGS layer corresponding to the first block;
a prefix generator which calculates a length of a prefix of first coefficients in the at least two subblocks; and
a significant coefficient encoding unit which combines the prefix with a suffix used to distinguish the first coefficients and which VLC encodes the first coefficients.

16. The entropy encoder of claim 15, wherein the prefix comprises consecutive 1's or 0's and the length of the prefix is calculated by:
$$[ \frac{c - m - 1}{3} ] \times 2 + ( m + 1 )$$
where m is an integer greater than or equal to 0.

17. The entropy encoder of claim 16, wherein m is extracted from a 16×16 table and the 16×16 table has a scan index in a 4×4 subblock and a recent non-zero index in lower layer coefficients.

18. The entropy encoder of claim 15, wherein a total number of the at least two subblocks is 2 and each subblock has 32 coefficients.

19. The entropy encoder of claim 15, wherein a total number of the at least two subblocks is 4 and each subblock has 16 coefficients.

20. The entropy encoder of claim 15, wherein the subblock divider divides the transform coefficients being scanned into a plurality of groups according to a scan order of the first block.

21. The entropy encoder of claim 15, wherein the subblock divider generates a subblock by dividing the first block into at least two groups and combing coefficients at same locations of the at least two groups.

22. An entropy decoder for losslessly decoding transform coefficients in a first block in a Fine-Granularity Scalability (FGS) layer of a multi-layer video signal, the entropy decoder comprising:
a transform coefficient calculator which calculates a range of a transform coefficient using a length of a prefix of the transform coefficient extracted from a Variable-Length Coding (VLC) coded bitstream of the transform coefficient;
a decoding unit which extracts a value of the transform coefficient from the range using a suffix of the coded transform coefficient and which VLC decodes the value of the transform coefficient; and
a block generator which combines first and second subblocks having the VLC decoded transform coefficient value to produce the first block.

23. The entropy decoder of claim 22, wherein the prefix comprises consecutive 1's or 0's and the length of the prefix is calculated by:
$$[ \frac{c - m - 1}{3} ] \times 2 + ( m + 1 )$$
where m is an integer greater than or equal to 0.

24. The entropy decoder of claim 23, wherein m is extracted from a 16×16 table and the 16×16 table has a scan index in a 4×4 subblock and a recent non-zero index in lower layer coefficients.

25. The entropy decoder of claim 22, wherein a total number of the at least two subblocks is 2 and each subblock has 32 coefficients.

26. The entropy decoder of claim 22, wherein a total number of the at least two subblocks is 4 and each subblock has 16 coefficients.

27. The entropy decoder of claim 22, wherein the first subblock and the second subblock are obtained by dividing a number of transform coefficients in the first block and a number of transform coefficients in the second block being scanned into a plurality of groups according to a scan order of the first block.

28. The entropy decoder of claim 22, wherein the first subblock and the second subblock are obtained by dividing the transform coefficients being scanned into a plurality of groups according to the scan order of the first block.
